(19) United States
(12) Patent Application Publication
(10) Pub. No.: US 2017/0082193 A1
(43) Pub. Date: Mar. 23, 2017

(54) SIMULATED STEPPED GEAR RATIO CONTROL METHOD FOR A BALL-TYPE CONTINUOUSLY VARIABLE TRANSMISSION

(71) Applicant: Dana Limited, Maumee, OH (US)

(72) Inventors: Jeffrey M. DAVID, Cedar Park, TX (US); T. Neil McLEMORE, Georgetown, TX (US); Gordon McINDOE, Volente, TX (US)

(21) Appl. No.: 15/265,163

(22) Filed: Sep. 14, 2016

Related U.S. Application Data
(60) Provisional application No. 62/220,023, filed on Sep. 17, 2015.

(51) Int. Cl. F16H 61/664; F16H 61/02

(52) U.S. Cl. CPC F16H 61/664; F16H 61/0213; F16H 2061/6643; F16H 2061/6644; F16H 2061/0227

(57) ABSTRACT

Provided herein is a control system for a multiple-mode continuously variable transmission having a ball planetary variator operably coupled to multiple-mode gearing. The control system has a transmission control module configured to receive a plurality of electronic input signals, and to determine a mode of operation from a plurality of control ranges based at least in part on the plurality of electronic input signals. The system also has a ratio shift schedule module configured to store at least one shift schedule map, and configured to determine a desired speed ratio of the variator based at least in part on the mode of operation.

### CROSS-REFERENCE

The present application claims priority to U.S. Provisional Patent Application No. 62/220,023, filed Sep. 17, 2015, which is incorporated herein by reference in its entirety.

### BACKGROUND OF THE INVENTION

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that may be implemented in a CVT may not be sufficient for some applications. A transmission may implement a combination of a CVT with one or more additional CVT stages, one or more fixed ratio range splitters, or some combination thereof in order to extend the range of available ratios. The combination of a CVT with one or more additional stages further complicates the ratio control process, as the transmission may have multiple configurations that achieve the same final drive ratio. The different transmission configurations can, for example, multiply input torque across the different transmission stages in different manners to achieve the same final drive ratio. However, some configurations provide more flexibility or better efficiency than other configurations providing the same final drive ratio.

The criteria for optimizing transmission control may be different for different applications of the same transmission. For example, the criteria for optimizing control of a transmission for fuel efficiency may differ based on the type of prime mover applying input torque to the transmission. Furthermore, for a given transmission and prime mover pair, the criteria for optimizing control of the transmission may differ depending on whether fuel efficiency or performance is being optimized.

### SUMMARY OF THE INVENTION

Provided herein a computer-implemented system for a vehicle having an engine coupled to an infinitely variable transmission having a ball-planetary variator (CVP), the computer-implemented system comprising: a digital processing device comprising an operating system configured to perform executable instructions and a memory device; a computer program including instructions executable by the digital processing, the computer program comprising a software module configured to manage a plurality of operating conditions of the vehicle; a plurality of sensors comprising: a vehicle speed sensor configured to sense a vehicle speed; an engine throttle position sensor configured to sense an engine throttle position; an accelerator pedal position sensor configured to sense an accelerator pedal position; a performance mode button configured to sense an operator's request for a performance mode; wherein the software module includes a plurality of calibration maps, each calibration map storing values of a target CVP speed ratio based on any one of the vehicle speed, the engine throttle position, the accelerator pedal position, and the performance mode. In some embodiments of the computer-implemented system, a first calibration map corresponds to a stepped shift mode of operating the transmission.

In some embodiments of the computer-implemented system, a second calibration map corresponds to a performance mode of operating the transmission.

In some embodiments of the computer-implemented system, a third calibration map corresponds to an economy mode of operating the transmission.

In some embodiments of the computer-implemented system, the first calibration map comprises discrete speed ratios for a range of accelerator pedal position signal values.

In some embodiments of the computer-implemented system, the first calibration map comprises discrete speed ratios for a range of engine throttle position signal values.

In some embodiments of the computer-implemented system, the CVP shift control module is adapted to switch between the engine throttle position signal and the accelerator pedal signal as an input to each calibration map.

In some embodiments of the computer-implemented system, the first calibration map contains five discrete speed ratio values for a range of accelerator pedal position signal values.

In some embodiments of the computer-implemented system, the first calibration map contains five discrete speed ratio values for a range of engine throttle pedal position signal values.

Provided herein is a computer-implemented system for a vehicle having an engine coupled to an infinitely variable transmission having a ball-planetary variator (CVP), the computer-implemented system comprising: a digital processing device comprising an operating system configured to perform executable instructions and a memory device; a computer program including instructions executable by the digital processing device, the computer program comprising a software module configured to manage a plurality of vehicle driving conditions; a plurality of sensors comprising: a vehicle speed sensor configured to sense a vehicle speed, an accelerator pedal position sensor configured to sense an accelerator pedal position, a performance mode switch configured to sense a driver's request for a performance mode, wherein the software module includes a plurality of calibration maps, each calibration map storing values of a target CVP speed ratio based at least in part on the vehicle speed, the accelerator pedal position, and the performance mode.

In some embodiments of the computer-implemented system, a first calibration map corresponds to a stepped shift mode of operating the transmission.

In some embodiments of the computer-implemented system, a second calibration map corresponds to a performance mode of operating the transmission.

In some embodiments of the computer-implemented system, a third calibration map corresponds to an economy mode of operating the transmission.

In some embodiments of the computer-implemented system, the first calibration map comprises discrete speed ratios for a range of accelerator pedal position signal values.

In some embodiments of the computer-implemented system, the first calibration map contains five discrete speed ratio values for a range of accelerator pedal position signal values.

Provided herein is a computer-implemented system for a vehicle having an engine coupled to an infinitely variable transmission having a ball-planetary variator (CVP), the computer-implemented system comprising: a digital processing device comprising an operating system configured to perform executable instructions and a memory device; a computer program including instructions executable by the digital processing device, the computer program comprising a software module configured to manage a plurality of vehicle driving conditions; a plurality of sensors comprising: a vehicle speed sensor configured to sense a vehicle speed, an engine throttle position sensor configured to sense an engine throttle position, a performance mode switch configured to sense a driver's request for a performance mode, wherein the software module includes a plurality of calibration maps, each calibration map storing values of a target CVP speed ratio based on the vehicle speed, the engine throttle position, and the performance mode.

In some embodiments of the computer-implemented system, a first calibration map corresponds to a stepped shift mode of operating the transmission.

In some embodiments of the computer-implemented system, a second calibration map corresponds to a performance mode of operating the transmission.

In some embodiments of the computer-implemented system, a third calibration map corresponds to an economy mode of operating the transmission.

In some embodiments of the computer-implemented system, the first calibration map comprises discrete speed ratios for a range of engine throttle position signal values.

In some embodiments of the computer-implemented system, the first calibration map contains five discrete speed ratio values for a range of engine throttle position signal values.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a block diagram of a basic driveline configuration of a continuously variable transmission (CVT) used in a vehicle.

FIG. 5 is a block diagram schematic of a transmission control system that is implemented in a vehicle.

FIG. 6 is a block diagram schematic of a CVP shift control sub-module that is implemented in the control system of FIG. 5.

### DETAILED DESCRIPTION OF THE INVENTION

An electronic controller is described herein that enables electronic control over a variable ratio transmission having a continuously variable ratio portion, such as a Continuously Variable Transmission (CVT), Infinitely Variable Transmission (IVT), or variator. The electronic controller is configured to receive input signals indicative of parameters associated with an engine coupled to the transmission. The parameters includes throttle position sensor values, accelerator pedal position sensor values, vehicle speed, gear selector position, user-selectable mode configurations, and the like, or some combination thereof. The electronic controller also receives one or more control inputs. The electronic controller determines an active range and an active variator mode based on the input signals and control inputs. The electronic controller controls a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission,”, U.S. Patent Application No. 62/158,847, each assigned to the assignee of the present application and hereby incorporated by reference herein in its entirety. However, the electronic controller is not limited to controlling a particular type of transmission but optionally configured to control any of several types of variable ratio transmissions.

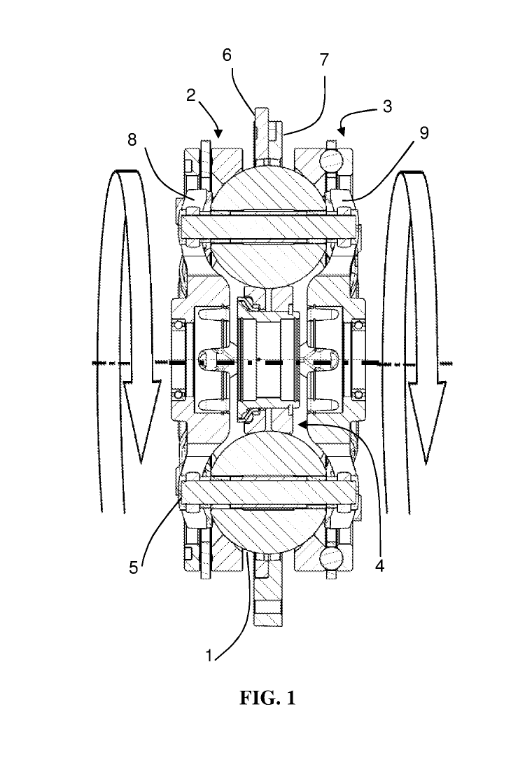

Provided herein are configurations of CVTs based on ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input 2 and output 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 9 is provided with a number of radially offset guide slots 9. The radial guide slots 8 and the radially offset guide slots 9 are adapted to guide the tiltable axles 5. The axles 5 is adjusted to achieve a desired ratio of input speed to output speed during operation of the CVT. In some embodiments, adjustment of the axles 5 involves control of the position of the first carrier member and the second carrier member to impart a tilting of the axles 5 and thereby adjusts the speed ratio of the variator. Other types of ball CVTs also exist, like the one produced by Milner, but are slightly different.

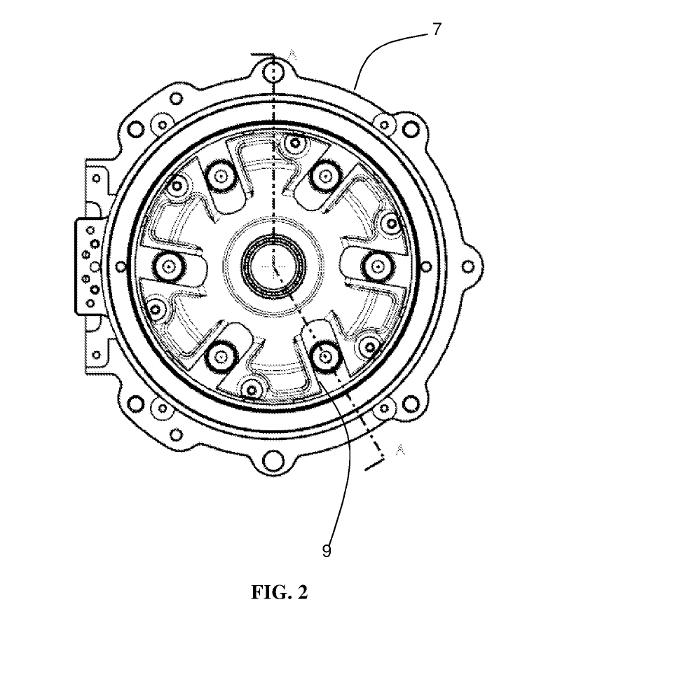

The working principle of such a CVP of FIG. 1 is shown on FIG. 2. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that is capable of being adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source may be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology.

Those of skill will recognize that the various illustrative logical blocks, modules, circuits, and algorithm steps described in connection with the embodiments disclosed herein, including with reference to the transmission control system described herein, for example, may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Software associated with such modules may reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and writes information to, the storage medium. In the alternative, the storage medium may be integral to the processor. The processor and the storage medium may reside in an ASIC. For example, in one embodiment, a controller for use of control of the IVT comprises a processor (not shown).

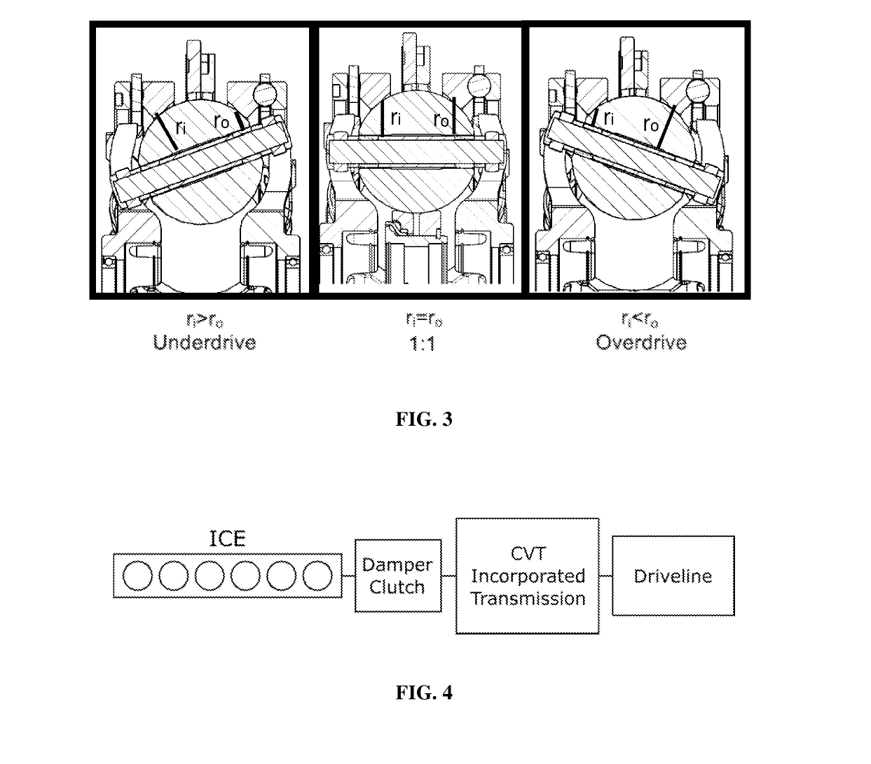

Referring now to FIG. 4, in one embodiment, a vehicle is equipped with a driveline having a torsional damper between an engine and an infinitely or continuously variable transmission (CVT) to avoid transferring torque peaks and vibrations that could damage the CVT (called variator in this context as well). In some configurations this damper is optionally coupled with a clutch for the starting function or to allow the engine to be decoupled from the transmission. In other embodiments, a torque converter (not shown), is used to couple the engine to the CVT or IVT. Other types of CVT's (apart from ball-type traction drives) are optionally used as the variator in this layout. In addition to the configurations above where the variator is used directly as the primary transmission, other architectures are possible. Various powerpath layouts are introduced by adding a number of gears, clutches and simple or compound planetaries. In such configurations, the overall transmission provides several operating modes; a CVT, an IVT, a combined mode and so on. A control system for use in an infinitely or continuously variable transmission will now be described.

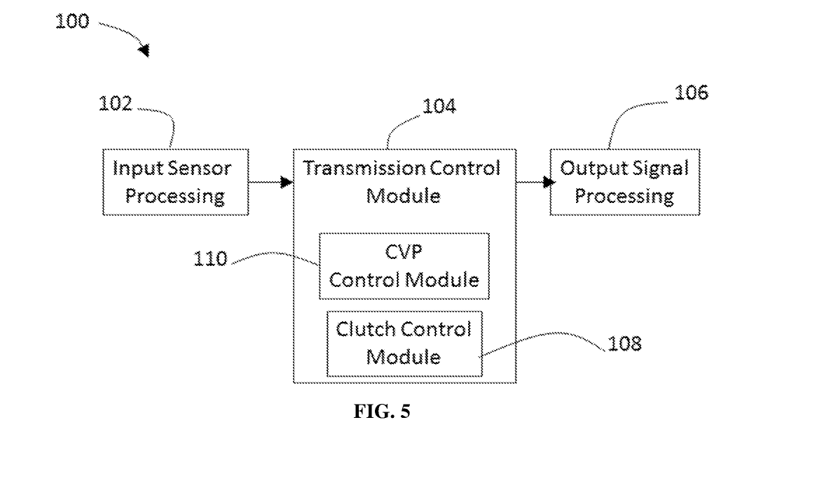

Referring now to FIG. 5, in one embodiment, a transmission controller 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 may include various sub-modules to perform routines such as signal acquisition, signal arbitration, or other known methods for signal processing. The output signal processing module 106 is configured to electronically communicate to a variety of actuators and sensors. In some embodiments, the output signal processing module 106 is configured to transmit commanded signals to actuators based on target values determined in the transmission control module 104. The transmission control module 104 includes a variety of sub-modules or sub-routines for controlling continuously variable transmissions of the type discussed here. For example, the transmission control module 104 includes a clutch control sub-module 108 that is programmed to execute control over clutches or similar devices within the transmission. In some embodiments, the clutch control sub-module may implement state machine control for the coordination of engagement of clutches or similar devices. The transmission control module 104 includes a CVP control sub-module 110 programmed to execute a variety of measurements and determine target operating conditions of the CVP, for example, of the ball-type continuously variable transmissions discussed here. It should be noted that the CVP control sub-module 110 incorporates a number of sub-modules for performing measurements and control of the CVP. One sub-module included in the CVP control sub-module 110 is described herein.

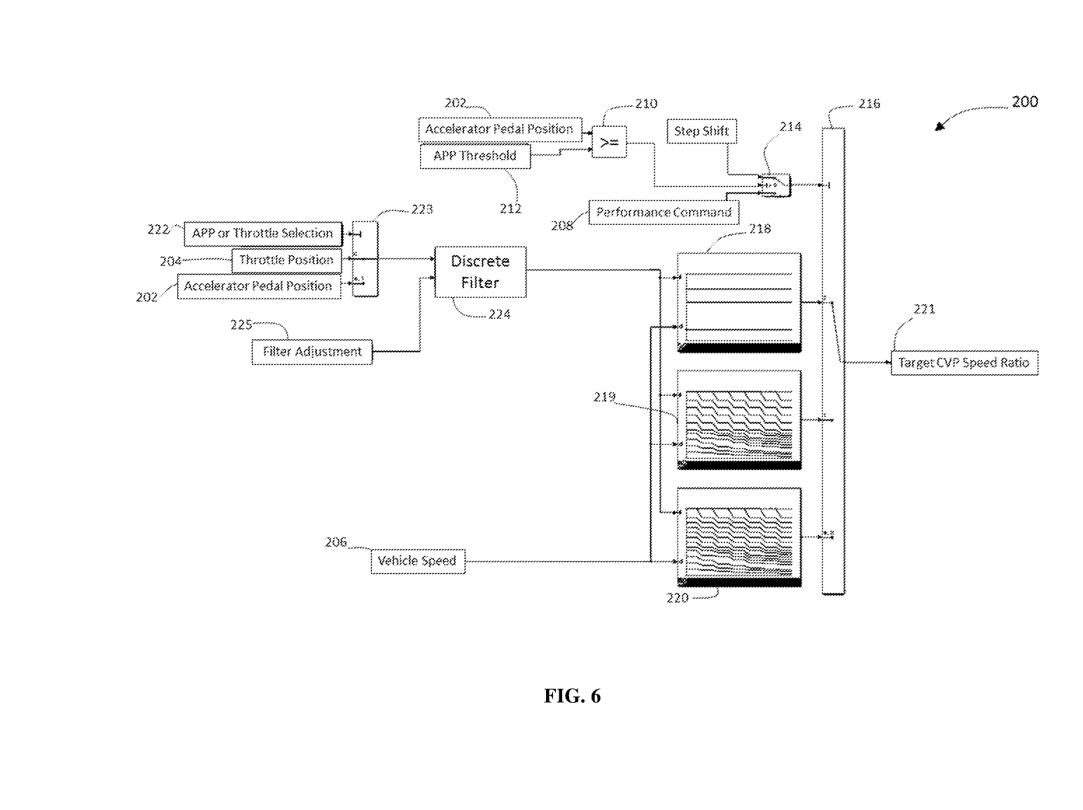

Turning now to FIG. 6, in one embodiment, a CVP shift control sub-module 200 is optionally implemented in the CVP control sub-module 110. The CVP shift control sub-module 200 receives an accelerator pedal position (“APP”) signal 202, which is indicative of a accelerator pedal position equipped in the vehicle (not shown). The CVP shift control module 200 receives a throttle position signal 204, which is indicative of a position of an engine throttle equipped on the vehicle (not shown). The CVP shift control sub-module 200 receives a vehicle speed signal 206, which is indicative of the speed of the vehicle. The CVP shift control sub-module 200 receives a performance command signal 208, which is indicative of a user's desired performance. For example, the signal 208 originates from a switch or button mounted in the vehicle that the user accesses while operating the vehicle. The signal originating from the switch is indicative of, for example, a desire to operate the vehicle in and “economy” mode or in a “performance” mode.

In one embodiment, the CVP shift control sub-module 200 passes the APP signal 202 to a comparison block 210 where the APP signal 202 is compared to a calibration variable 212. The calibration variable 212 is read from memory and is indicative of an accelerator pedal position threshold. The comparison block 210 determines if the APP signal 202 is above the value of the calibration variable 212. The resulting comparison made in comparison block 210 is passed to a switch block 214. The switch block 214 will switch between two values based on the result of the comparison block 210. For example, if the APP signal 202 is greater than the calibration value 212, the comparison block 210 passes a true, or a 1, signal to the switch block 214. The switch block 214 passes a value indicative of a request for a stepped shift mode. If the APP signal 202 is less than the calibration value 212, the comparison block 210 passes a false, or a 0, signal to the switch block 214. The switch block 214 passes the performance command signal 208. The value passed from the switch block 214 is received at a switch block 216. The switch block 216 evaluates the value passed from the switch block 214 to determine which value to pass out of the switch.

For example, the switch block 216 receives an input from a first calibration map 218. The first calibration map 218 is configured to store calibration values for speed ratio based on the vehicle speed signal 206 and either the APP signal 202 or the throttle position signal 204. The first calibration map 218 corresponds to a stepped shift mode of operating the transmission. In some embodiments, the first calibration map 218 is configured to store calibration values for speed ratio based on other signals indicative of vehicle operation, for example, CVP input speed, transmission output speed, among others.

The switch block 216 receives an input from a second calibration map 219. The second calibration map 219 is configured to store calibration values for speed ratio based on the vehicle speed signal 206 and either the APP signal 202 or the throttle position signal 204. The second calibration map 219 corresponds to a performance mode of operating the transmission, namely with a smooth transition between CVP ratios or clutch engagement events. In some embodiments, the second calibration map 219 is configured to store calibration values for speed ratio based on other signals indicative of vehicle operation, for example, CVP input speed, transmission output speed, among others.

The switch block 216 receives an input from a third calibration map 220. The third calibration map 220 is configured to store calibration values for speed ratio based on the vehicle speed signal 206 and either the APP signal 202 or the throttle position signal 204. The third calibration map 220 corresponds to an economy mode of operating the transmission, namely a smooth and efficient operation of the transmission. In some embodiments, the third calibration map 220 is configured to store calibration values for speed ratio based on other signals indicative of vehicle operation, for example, CVP input speed, transmission output speed, among others.

The switch block 216 passes a target CVP speed ratio signal 221 as an output signal from the CVP shift control sub-module 200. The target CVP speed ratio signal 221 is further used within the transmission control module 104.

As mentioned previously, the first calibration map 218, the second calibration map 219, and the third calibration map 220 store values for target speed ratio based on the vehicle speed signal 206, the APP signal 202, and/or the throttle position signal 204. In some implementations of the CVP shift control sub-module 200, a selection is optionally made between the use of the APP signal 202 or the throttle position 204 depending upon the value set by a calibration variable 222, for example. The calibration variable 222 is read from memory. In other embodiments, the calibration variable 222 is a signal received from another sub-module in the transmission control module 100 that determines the conditions under which the APP signal 204 is to be used or the throttle position signal 204 is to be used. A switch block 223 receives the calibration variable 222 and passes the appropriate signal to a discrete filter 224. The discrete filter 224 is optionally adjusted by a calibration variable 225.

In one embodiment, the first calibration map 218 is a calibratable step shift map that has 5 discrete CVT speed ratios. The first two are calibrated for aggressive Mode 1 acceleration. The third is chosen to trigger a synchronous mode shift. The fourth is chosen for aggressive Mode 2 acceleration. The fifth is set for full overdrive to allow maximum vehicle speed. The driver perception will be similar to a six speed automatic with six discreet ratios (5 from CVP ratio change and one from Mode shift). The step shift ratio control map is optionally recalibrated for a non-synchronous mode shift strategy. The step shift ratio control map is optionally recalibrated to simulate any number of discrete ratio steps and is not limited to any specific value.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented system for a vehicle having an engine coupled to an infinitely variable transmission having a ball-planetary variator (CVP), the computer-implemented system comprising:
a digital processing device comprising an operating system configured to perform executable instructions and a memory device;
a computer program including instructions executable by the digital processing, the computer program comprising a software module configured to manage a plurality of operating conditions of the vehicle;
a plurality of sensors comprising:
a vehicle speed sensor configured to sense a vehicle speed;
an engine throttle position sensor configured to sense an engine throttle position;
an accelerator pedal position sensor configured to sense an accelerator pedal position;
an operating mode button configured to sense an operator's request for an operating mode;
wherein the software module includes a plurality of calibration maps, each calibration map storing values of a target CVP speed ratio based on any one of the vehicle speed, the engine throttle position, the accelerator pedal position, and the operating mode.

2. The computer-implemented system of claim 1, further comprising a first calibration map corresponding to a stepped shift mode of operating the transmission.

3. The computer-implemented system of claim 2, further comprising a second calibration map corresponding to a performance mode of operating the transmission.

4. The computer-implemented system of claim 3, further comprising: a third calibration map corresponding to an economy mode of operating the transmission.

5. The computer-implemented system of claim 4, wherein the first calibration map comprises discrete speed ratios for a range of accelerator pedal position signal values.

6. The computer-implemented system of claim 5, wherein the first calibration map comprises discrete speed ratios for a range of engine throttle position signal values.

7. The computer-implemented system of claim 6, wherein the software module is adapted to switch between the engine throttle position signal and the accelerator pedal signal as an input to each calibration map.

8. The computer-implemented system of claim 7, wherein the first calibration map contains discrete speed ratio values for a range of accelerator pedal position signal values.

9. The computer-implemented system of claim 8, wherein the first calibration map contains discrete speed ratio values for a range of engine throttle pedal position signal values.

10. The computer-implemented system of claim 9, wherein the first calibration map stores values of speed ratio based at least in part on the vehicle speed.

11. The computer-implemented system of claim 10, wherein the plurality of sensors further comprise a CVP output speed.

12. The computer-implemented system of claim 11, wherein the first calibration map stores values of speed ratio based at least in part on the CVP output speed.

13. A computer-implemented system for a vehicle having an engine coupled to an infinitely variable transmission having a ball-planetary variator (CVP), the computer-implemented system comprising:
a digital processing device comprising an operating system configured to perform executable instructions and a memory device;
a computer program including instructions executable by the digital processing device, the computer program comprising a software module configured to manage a plurality of vehicle driving conditions;
a plurality of sensors comprising:
a vehicle speed sensor configured to sense a vehicle speed,
an accelerator pedal position sensor configured to sense an accelerator pedal position,
a performance mode switch configured to sense a driver's request for a performance mode,
wherein the software module includes a plurality of calibration maps, each calibration map storing values of a target CVP speed ratio based at least in part on the vehicle speed, the accelerator pedal position, and the performance mode.

14. The computer-implemented system of claim 13, further comprising a first calibration map corresponding to a stepped shift mode of operating the transmission.

15. The computer-implemented system of claim 14, further comprising a second calibration map corresponding to a performance mode of operating the transmission.

16. The computer-implemented system of claim 15, further comprising a third calibration map corresponding to an economy mode of operating the transmission.

17. The computer-implemented system of claim 14, wherein the first calibration map comprises discrete speed ratios for a range of accelerator pedal position signal values.

18. The computer-implemented system of claim 14, wherein the first calibration map contains discrete speed ratio values for a range of accelerator pedal position signal values.

19. A computer-implemented system for a vehicle having an engine coupled to an infinitely variable transmission having a ball-planetary variator (CVP), the computer-implemented system comprising:
a digital processing device comprising an operating system configured to perform executable instructions and a memory device;
a computer program including instructions executable by the digital processing device, the computer program comprising a software module configured to manage a plurality of vehicle driving conditions;
a plurality of sensors comprising:
a vehicle speed sensor configured to sense a vehicle speed,
an engine throttle position sensor configured to sense an engine throttle position,
a performance mode switch configured to sense a driver's request for a performance mode,
wherein the software module includes a plurality of calibration maps, each calibration map storing values of a target CVP speed ratio based on the vehicle speed, the engine throttle position, and the performance mode.

20. The computer-implemented system of claim 19, further comprising:
a first calibration map corresponding to a stepped shift mode of operating the transmission;
comprising a second calibration map corresponding to a performance mode of operating the transmission; and
a third calibration map corresponding to an economy mode of operating the transmission;
wherein the first calibration map comprises discrete speed ratios for a range of engine throttle position signal values, and
wherein the first calibration map contains five discrete speed ratio values for a range of engine throttle position signal values.
